(19) United States
(12) Patent Application Publication
(10) Pub. No.: US 2006/0137959 A1
(43) Pub. Date: Jun. 29, 2006

(54) Bill discriminating device

(76) Inventors: Nobuyuki Iida, Sakado-shi (JP); Noboru Yamagishi, Sakado-shi (JP); Kazuo Takeda, Sakado-shi (JP); Yukio Ito, Sakado-shi (JP)

Correspondence Address: ERIC ROBINSON, PMB 955, 21010 SOUTHBANK ST., POTOMAC FALLS, VA, 20165, US

(21) Appl. No.: 11/315,343

(22) Filed: Dec. 23, 2005

(30) Foreign Application Priority Data
Dec. 27, 2004 (JP) 2004-376723

(51) Int. Cl. G07D 7/00; G07F 7/04; G06K 9/00; G06K 7/00

(52) U.S. Cl. 194/207

(57) ABSTRACT

The bill discriminating device includes: a body; and a mask portion, the body includes a main substrate having a light source, the mask portion includes a bill insertion port formed to be placed in a front surface of the bill discriminating device, and a bill chute passage having one end connected to a bill conveying passage and the other end extending to the bill insertion port, at least one surface of the bill chute passage is formed of a light guide member including a portion extending from the light source to the bill insertion port, and light emitted from the light source is optically connected to the bill insertion port via the light guide member.

### BACKGROUND OF THE INVENTION

1. Field of the Invention

The present invention relates to a bill discriminating device in which a bill insertion port is protected by a mask portion that covers a front surface of the bill discriminating device except the bill insertion port, and light from a light source apart from the bill insertion port in the bill discriminating device is guided to the bill insertion port via a light guide member to illuminate the bill insertion port over a wide range, thereby facilitating discrimination from the outside.

2. Related Background Art

Many vending machines include no security camera, and are placed in insufficiently illuminated places. Thus, bills stored in a vending machine can be stolen without many persons and much equipment, though it takes a relatively long time. For stealing bills in a vending machine, a bill insertion port of a bill discriminating device is often broken and the bills in the bill discriminating device are taken out of the broken port. Thus, there is a strong need from users for a bill discriminating device that can be protected against such a crime.

One method for solving the above-described problem is to reduce a vertical width of a bill insertion port in a mask portion of a bill discriminating device as small as possible, and form the entire surface of the mask portion except the bill insertion port from a rigid member to increase strength of the bill insertion port and a periphery thereof. However, reduction in an area of the bill insertion port as described above makes it difficult for customers who buy products from a vending machine placed in an insufficiently illuminated place to discriminate the bill insertion port. Thus, in order for the customers to be able to easily discriminate the bill insertion port in the insufficiently illuminated place, the bill insertion port itself needs to have a light emitting function.

For example, Japanese Utility Model Application Laid-Open No. H2-38666 discloses a configuration in which a bill insertion port of a bill discriminating device is formed of a material consisting of light harvesting resin, and the bill insertion port is illuminated by a light source placed in a vending machine and outside the bill discriminating device so that the bill insertion port of the bill discriminating device has a light emitting function. In the above-described configuration, the light source is placed outside the bill discriminating device, and thus the bill insertion port and the light source are placed apart from each other under physical constraints. Thus, the intensity of light emitted from the light source must be relatively high, and the entire bill insertion port cannot be illuminated even with a high intensity light source. Also, use of the high intensity light source causes inconvenience in terms of the life of the light source.

Japanese Utility Model Application Laid-Open No. H5-30215 discloses a configuration in which a bottom surface of a bill insertion port is formed of a light transmitting material, a pyramid-shaped member formed of a light reflecting material is placed below the bottom surface, and a light emitting diode (LED) is placed in the pyramid-shaped member so that the bill insertion port has a light emitting function. With the above-described configuration, direct light from the LED and reflected light from the pyramid-shaped member cause the bill insertion port to emit light. However, in the above-described configuration, the pyramid-shaped member and the light emitting diode (LED) need to be placed, thereby increasing a size of an opening of the bill insertion port. Also, a separate substrate needs to be placed close to the bill insertion port, thereby increasing complexity of a production process and production costs. Further, the entire bill insertion port cannot be illuminated, though a periphery of the LED can be illuminated.

Japanese Patent No. 3220235 discloses a configuration in which a bottom surface of a bill insertion port is formed of a colored translucent synthetic resin member, and an LED is placed on a substrate placed inside the bottom surface to illuminate the bill insertion port. Like the above-described configuration, this configuration encounters problems of a significant increase in production costs and impossibility to illuminate the entire bill insertion port.

### SUMMARY OF THE INVENTION

Therefore, the present invention has an object to provide a bill discriminating device in which light from a light source on a main substrate placed apart from a bill insertion port in the bill discriminating device is guided to the bill insertion port via a light guide member to illuminate the bill insertion port over a wide range with the guided light, thereby eliminating the need for placing a separate substrate close to the bill insertion port. Such a configuration provides a simple production process and significantly reduces production costs. Further, the present invention has another object to provide a bill discriminating device that allows light guided from a light source via a light guide member to linearly illuminate a bill insertion port along a long side thereof and illuminate the entire bill insertion port in addition to an extremely limited range in the center of the bill insertion port.

The bill discriminating device according to the present invention includes: a body; and a mask portion, the body includes a main substrate having a light source, the mask portion includes a bill insertion port formed to be placed in a front surface of the bill discriminating device, and a bill chute passage having one end connected to a bill conveying passage and the other end extending to the bill insertion port, at least one surface of the bill chute passage is formed of a light guide member including a portion extending from the light source to the bill insertion port, and light emitted from the light source is optically connected to the bill insertion port via the light guide member.

In the above-described bill discriminating device, the main substrate having the light source is placed apart from the bill insertion port in the bill discriminating device. The light guide member is formed to have a lateral width matching a size of at least one light source at a connection end to the light source, and a width matching a lateral width of the bill insertion port at the other end of the bill chute passage extending to the bill insertion port.

Further, in the above-described bill discriminating device, the mask portion is preferably formed of a rigid member such as a die-casting alloy.

With the above-described configuration, the bill insertion port and the light source are placed apart from each other via the light guide member, and thus the need can be eliminated for placing a separate substrate close to the bill insertion port by placing the light source on the main substrate. This provides a simple production process, and significantly reduces production costs. Further, the above-described configuration allows light guided from the light guide via the light guide member to linearly illuminate the bill insertion port along a long side thereof and illuminate the entire bill insertion port in addition to an extremely limited range in the center of the bill insertion port.

### BRIEF DESCRIPTION OF THE DRAWINGS

FIG. 1 shows a section of a bill discriminating device according to the present invention; and

FIG. 2 shows a state where a bill discriminating portion is removed from a body in the bill discriminating device according to the present invention.

### DESCRIPTION OF THE PREFERRED EMBODIMENTS

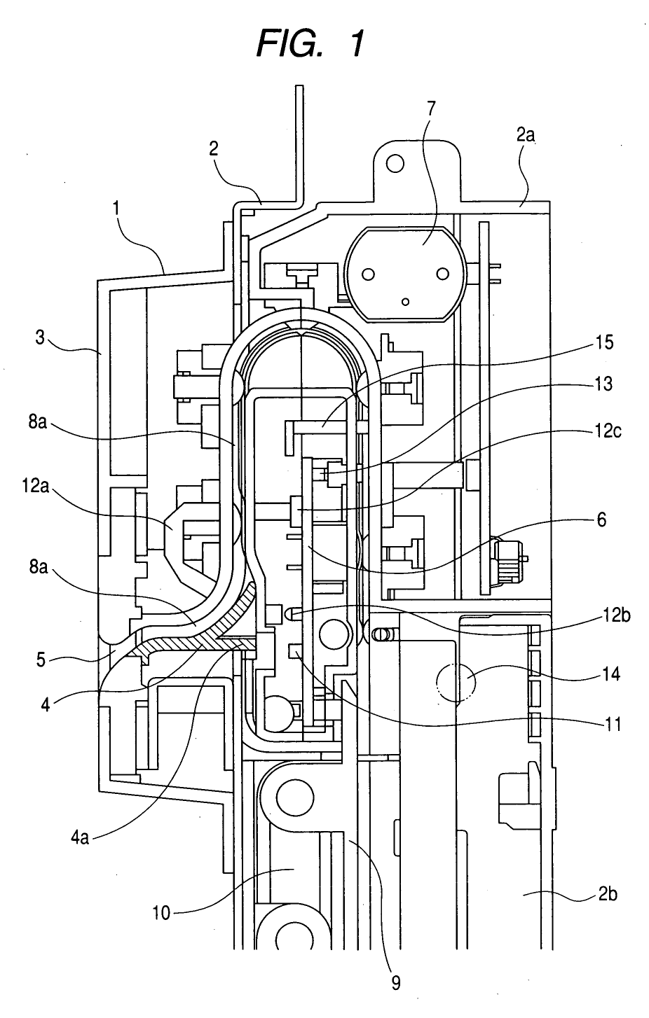

FIG. 1 shows a section of a bill discriminating device according to the present invention. The bill discriminating device according to the present invention includes a mask portion 1 having a front portion 3 in a front surface, and a body 2. The body 2 includes a bill discriminating portion 2a and a bill accommodating portion 2b. The bill discriminating portion 2a is rotatably connected to the body 2 by a rotation shaft 14 so that the portion 2a is detachably mounted to the body 2, and engages the mask portion 1 when mounted. The mask portion 1 has a bill insertion port 5 that is placed in a front surface of the bill discriminating device and receives inserted bills. The mask portion 1 also includes a bill chute passage 8a having one end extending to the bill insertion port 5 and the other end connected to a bill conveying passage. At least one surface of the bill chute passage 8a is formed of a light guide member 4. At least one surface may be an upper surface or a lower surface. The bill discriminating portion 2a includes a bill conveying passage 8 that has one end connected to the other end of the bill chute passage 8a and conveys the inserted bills. When the bill discriminating portion 2a is mounted to the body 2 and engages the mask portion 1, the bill conveying passage 8 forms one passage extending from the bill insertion port 5 to a stacker in the bill accommodating portion 2b. The bill discriminating portion 2a includes a bill discriminating sensor that discriminates the bills conveyed through the bill conveying passage 8. The bill accommodating portion 2b is mounted below the bill discriminating portion 2a in the body 2. The bill accommodating portion 2b has a surface parallel to front and rear surfaces of the bill discriminating device and facing in parallel with a surface that constitutes part of the bill conveying passage 8 of the bill discriminating portion 2a. The surface of the bill accommodating portion 2b facing in parallel with the surface that constitutes part of the bill conveying passage 8 of the bill discriminating portion 2a constitutes part of the bill conveying passage 8 together with the surface that constitutes part of the bill conveying passage 8 of the bill discriminating portion 2a when the bill discriminating portion 2a is mounted to the body 2. The bill accommodating portion 2b includes a lift member 9 that presses the bills guided by the stacker toward the rear surface of the bill discriminating device perpendicularly to the rear surface, and a drive portion 10 that includes a stack motor (not shown, hereinafter the same) and a pantograph-shaped member, and drives the stack motor to expand and contract the pantograph-shaped member and move the lift member 9. The bill accommodating portion 2b includes a stack portion in which the drive portion 10 is placed, and a bill accommodating case. The lift member 9 aligns the bills guided to a stack position in the bill accommodating portion 2b via the bill conveying passage 8 and accommodates the bills in the bill accommodating case.

In the state in FIG. 1, when a bill is inserted into the bill insertion port 5, the bill passes through the bill chute passage 8a and reaches the bill conveying passage 8. When the bill reaches the bill conveying passage 8, a bill insertion sensor 12 detects the insertion of the bill. The bill insertion sensor 12 includes a light source 12b and a light receiving sensor 12c placed on the main substrate 6 in a bill conveying direction on one side of the bill conveying passage 8, and a prism 12a placed on the other side of the bill conveying passage 8 for guiding light emitted from the light source 12b to illuminate the bill and guiding the light from the light source 12b having passed through the bill to illuminate the bill again from the other side of the bill conveying passage 8. The bill insertion sensor 12 thus configured detects the insertion of the bill based on changes in output of the light receiving sensor 12c when both the light that illuminates the bill from one side of the bill conveying passage and the light that illuminates the bill from the other side are blocked by the bill.

When the bill insertion sensor 12 detects the insertion of the bill, the bill conveying motor 7 is activated to drive bill conveying means (not shown, hereinafter the same). In the bill discriminating portion 2a, a conveying position detection sensor 13 is provided along the bill conveying passage 8, and detects a conveying position of the bill. When the inserted bill reaches an escrow position, the bill conveying passage 8 is blocked by a shutter member 15 so as to prevent the inserted bill having reached the escrow position from going backward through the bill conveying passage 8. When the conveying position detection sensor 13 and the bill insertion sensor 12 detect the bill in this order before the bill conveying passage 8 is blocked by the shutter member 15, it is determined that the bill is improperly taken out, and bill discriminating means outputs no bill determining signal.

When the bill discriminating sensor determines the effectiveness of the bill, and determines the bill as effective, the shutter member 15 blocks the bill conveying passage 8. The bill is discriminated using a magnetic sensor and an optical sensor together to determine whether the bill is true by pattern matching of the inserted bill. In this determination, the bill discriminating sensor determines a bill within a certain range as an effective bill. When the bill discriminating sensor determines that the inserted bill is not effective, the bill is returned to the bill insertion port 5 through the bill conveying passage 8 and the bill chute passage 8a in an opposite direction to a bill inserting direction with the shutter member 15 opening the bill conveying passage 8. When the bill discriminating sensor determines that the inserted bill is effective, the bill discriminating means outputs a bill determining signal, and the bill is conveyed to the stacker in the bill accommodating portion 2b.

In order to protect against recent crimes, the bill insertion port 5 formed in the mask portion 1 is preferably protected by the mask portion 1 formed of a rigid member such as die casting. The bill insertion port 5 is formed into a rectangular shape matching a section of a bill perpendicular to the inserting direction, and has long sides parallel to an upper surface of the bill discriminating device, and short sides parallel to right and left side surfaces of the bill discriminating device. The short side preferably has a width of 7 to 12 mm. Thus, for a vending machine placed in a place without illumination therearound, it is extremely difficult for a customer to discriminate the bill insertion port 5 during the night. For such a reason, means for indicating the bill insertion port 5 with some method is needed.

In the present invention, a light source 11 placed on the main substrate 6 in the body 2, and the light guide member 4 optically connected to the light source 11 are used to guide light from the light source 11 to the bill insertion port 5 via the light guide member 4 and illuminate the bill insertion port 5 with the guided light. The light guide member 4 includes a portion 4a that forms at least one surface of the bill chute passage 8a in the mask portion 1 and extends from the light source 11 to the bill insertion port 5. The portion 4a extending from the light source 11 to the bill insertion port 5 extends from the bill insertion port 5 to the light source 11 perpendicularly to the front and rear surfaces of the bill discriminating device. The portion 4a extending from the light source 11 to the bill insertion port 5 is formed into, for example, a sheet with a triangular shape so as to have a width matching a size of at least one light source at an optical connection end to the light source 11 and a width matching a length of the long side of the bill insertion port 5 at a boundary between the bill chute passage 8a and the bill insertion port 5 in the mask portion 1. The light guide member 4 including the portion 4a that forms part of at least one surface of the bill chute passage 8a and extends from the light source 11 to the bill insertion port 5 may be a general optical fiber. A distance of mode dispersion of propagating light is insignificantly extremely short, and thus the light guide member 4 may be formed of a plastic fiber or a polymer fiber having a plastic core and a plastic cladding. The light guide member 4 may be formed of a material such as polyimide fluoride for an optical waveguide. The light emitted from the light source 11 reaches the bill insertion port 5 via the light guide member 4 and illuminates the bill insertion port 5. A surface of an end of the light guide member 4 on the side of the bill insertion port 5 is formed to have grain (fine asperities) so that the light propagating through the light guide member 4 is scattered. Thus, the light having reached the bill insertion port 5 linearly illuminate the bill insertion port 5 along the long side thereof and illuminate the entire bill insertion port in addition to an extremely limited range in the center of the bill insertion port 5.

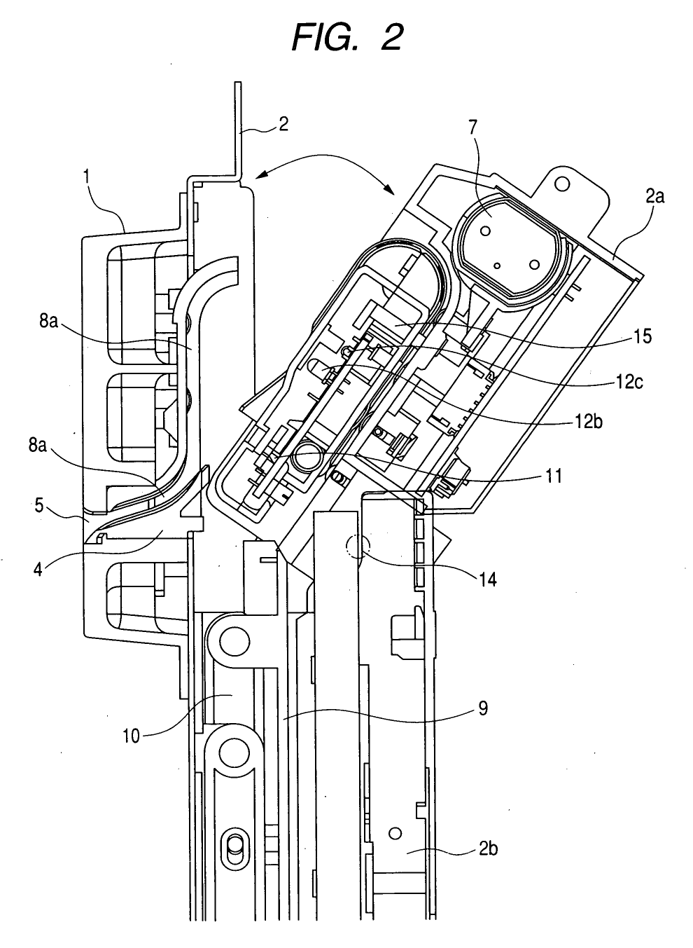

As shown in FIG. 2, the bill discriminating portion 2a is detachably mounted to the body 2 by the rotation shaft 14. The main substrate 6 on which the light source 11 is placed in the bill discriminating portion. On the other hand, the light guide member 4 that guides the light emitted from the light source 11 to the bill insertion port 5 is placed in the mask portion 1 having the bill insertion port 5 formed therein. The mask portion 1 engages the body 2 with a screw or the like. When the bill discriminating portion 2a is removed from the body 2, as shown in FIG. 2, the optical connection end of the light guide member 4 placed in the mask portion 1 to the light source 11 is relatively separated from the light source 11 placed on the main substrate 6. Thus, an optical path extending from the light source 11 placed on the main substrate 6 of the bill discriminating portion 2a to the bill insertion port 5 formed in the mask portion 1 via the light guide member 4 placed in the mask portion 1 is formed when the bill discriminating portion 2a is mounted to the body 2.

Returning to FIG. 1, the bill insertion port 5 formed in the mask portion 1 and the light source 11 placed on the main substrate 6 in the body 2 are placed apart from each other with the light guide member 4 therebetween. This configuration eliminates the need for placing a separate substrate in the mask portion 1 having the bill insertion port 5 by placing the light source 11 on the main substrate 6. Specifically, electronic elements such as detection elements are collectively placed on the main substrate 6, and the mask portion 1 has no electronic element. The light guide member 4 may be formed into a U shape or an L shape rather than a shape linearly extending from the bill insertion port 5 to the light source 11 to freely select a position for the light source 11 on the main substrate 6. Thus, the prism 12a placed along the bill conveying passage 8 may be used to cause one light source to serve as both the light source 11 that illuminates the bill insertion port 5 and the light source 12b that constitutes the bill insertion sensor 12. Further, as the light source 11, a general light emitting diode (LED) may be used, or a surface light emitting element may be used. In the above-described embodiment, part of at least one surface of the bill chute passage 8a is formed of the light guide member 4, and more specifically, part of an upper surface and/or a bottom surface of the bill chute passage 8a may be formed of the light guide member 4.

As described above, in the bill discriminating device according to the present invention, the light from the light source 11 on the main substrate 6 placed apart from the bill insertion port 5 in the bill discriminating device is guided to the bill insertion port 5 via the light guide member 4 to illuminate the bill insertion port 5 over a wide range with the guided light, thereby eliminating the need for placing a separate substrate close to the bill insertion port 5. Further, the bill discriminating device according to the present invention allows the light emitted from the light source 11 to linearly illuminate the bill insertion port 5 along the long side thereof and illuminate the entire bill insertion port in addition to an extremely limited range in the center of the bill insertion port 5.

The above description relates to the embodiment of the present invention, and the gist of the present invention should not be construed as limited to this. In the technical field of the present invention, various modifications may be made by those skilled in the art, and fall within the technical scope of the present invention as long as embodied devices caused by such modifications are equivalent to the present invention.

What is claimed is:

1. A bill discriminating device comprising:
a body; and
a mask portion,
wherein said body includes a main substrate having a light source,
said mask portion includes a bill insertion port formed to be placed in a front surface of said bill discriminating device, and a bill chute passage having one end connected to a bill conveying passage and the other end extending to said bill insertion port, at least one surface of the bill chute passage is formed of a light guide member including a portion extending from said light source to said bill insertion port, and
light emitted from said light source is optically connected to said bill insertion port via said light guide member.

2. The bill discriminating device according to claim 1, wherein said light guide member is formed to have a lateral width matching a size of at least one light source at a connection end to said light source, and a width matching a lateral width of said bill insertion port at the other end of said bill chute passage extending to said bill insertion port.

3. The bill discriminating device according to claim 1, wherein said mask portion is formed of a rigid member.

4. The bill discriminating device according to claim 1, wherein said light source is a light emitting diode (LED).

5. The bill discriminating device according to claim 1, wherein said body includes a bill discriminating portion detachably mounted to said body, said bill discriminating portion includes said main substrate having said light source, said mask portion engages said body, an optical path extending from said light source to the bill insertion port via said light guide member is formed when said bill discriminating portion is mounted to said body, and no optical path is formed when said bill discriminating portion is removed from said body.
